(19) United States
(12) Patent Application Publication
(10) Pub. No.: US 2025/0130417 A1
(43) Pub. Date: Apr. 24, 2025

(54) OPTICAL ENHANCEMENT OF PHASE MODULATION DEPTH FOR A PHASE LIGHT MODULATOR

(71) Applicant: ARIZONA BOARD OF REGENTS ON BEHALF OF THE UNIVERSITY OF ARIZONA, Tucson, AZ (US)

(72) Inventor: Yuzuru Takashima, Tucson, AZ (US)

(73) Assignee: ARIZONA BOARD OF REGENTS ON BEHALF OF THE UNIVERSITY OF ARIZONA, Tucson, AZ (US)

(21) Appl. No.: 18/686,560

(22) PCT Filed: Aug. 24, 2022
(86) PCT No.: PCT/US2022/041317

§ 371 Date: Feb. 26, 2024

Related U.S. Application Data
(60) Provisional application No. 63/236,490, filed on Aug. 24, 2021.

(51) Int. Cl. G02B 26/06; G02B 27/28

(52) U.S. Cl. CPC G02B 26/06; G02B 27/286; G02B 27/283

(57) ABSTRACT

An optical architecture for enhancing phase modulation depth for a phase light modulator includes a laser light source, a 4f, 1:1 relay where a tilted mirror with a center hole is placed at the backfocal point of the first lens. A vertically polarized (VP) and collimated light is deflected by a polarized beam splitter (PBS), followed by passing through a Quarter Wave Plate (QWP) that converts linear polarization (LP) to right circular polarization (RCP). Upon interaction of the RCP light with PLM, spatial phase is modulated by 2kd(i,j). PLM reflects and modulates phase of light while changing the handness of polarization from RHP to left hand circular polarization (LCP). The 2^{nd} interaction with QWP changes polarization of light from LCP to horizontally polarized (HP) light. The mirror M1 is placed at a half of the Talbot distance from the PLM as described later. The reflected light by M1 is a HP light, therefore it goes through the PBS and is converted to RCP by the 3^{rd} interaction with QWP. Finally the light is modulated by the PLM with the same phase modulation profile and reflected to the direction along the incident laser beam via QWP and PBS. After the laser beam is doubly modulated, the laser beam diffracted towards direction defined by the CGH pattern displayed on PLM. The diffracted beam is reflected by the mirror placed in the 4f 1:1 collimating optics followed by a collimating optics for beam steering.

### CROSS-REFERENCE TO RELATED APPLICATION

The present application relates and claims priority to U.S. Provisional Patent Application No. 63/236,490, filed Aug. 24, 2021, the entirety of which is hereby incorporated by reference.

### GOVERNMENT FUNDING

N/A

### FIELD OF THE INVENTION

The present disclosure is directed generally to phase light modulators such as those used in, for example, LIDAR applications.

### BACKGROUND

A phase light modulator (PLM) is a device that modulates phase of light in a 2 dimensional manner. PLM devices are commonly manufactured by a Liquid Crystal on Silicon (LCoS) process. PLMs based on the LCoS device process are commercially available, for example from HoloEye, Santec, and Hamamatsu. The drawback in general of such Liquid Crystal (LC) based PLM is slow switching speed. Due to the relatively slow (˜ms) response time of LC, application of LCoS PLMs are mainly for displaying images and manipulation of micro particles that do not require high speed phase modulation.

In contrast, a faster laser beam modulation is needed for beam steering for light detection and ranging (lidar). Especially a solid state or MEMS (Micro Electro Mechanical System) based PLM is highly anticipated to replace mechanical scanning modalities such as rotating mirrors. A fast laser beam steering enables a real time recognition of distant object with high enough scan rate. Micro Electro Mechanical System (MEMS) based PLMs in general has a faster switching time (˜us), compared to the switching time of LC. Such MEMS based PLM operates in a piston mode of electro dynamically controlled array of micromirrors.

Accordingly, there is a need in the art for faster laser beam modulation is needed for beam steering for certain applications, such as LIDAR.

### SUMMARY

The present disclosure is directed to a device, system and method of phase modulation depth for a phase light modulator.

According to an aspect is a phase light modulator for use in an optical system having a laser light source that emits light, comprising a plurality of pixelated micromirrors each of which is selectively movable to vary height in the direction of incidence of the light, wherein variation of height of the micromirrors is represented by d(i,j) where (i,j) indicates location of pixel; and means for modulating the micromirrors in a pixelated manner, whereby upon reflection of light by such spatially variable height and pixelated mirrors, phase of light is modulated 2kd(i,j) where k is a light propagation constant in free space, 2π/λ.

According to an embodiment, the range of d(i,j) is chosen so that maximum displacement of micromirror d(I,j)=d_max=λ/2, or 2π phase modulation, where lambda is wavelength of laser.

According to an aspect is an optical system for enhancing phase modulation depth for a phase light modulator, comprising a laser light source; a relay having first and second lenses; a tilted mirror having a central hole formed therethrough positioned between the first and second lenes, whereby vertically polarized and collimated light is formed along a light path; a polarized beam splitter positioned in the light path to receive and deflect the vertically polarized and collimated light; a quarter wave plate positioned such that the light deflected by the polarized beam splitter passes therethrough and converts linear polarization light to right circular polarization light; a phase light modulator positioned in spaced relation to one side of the quarter wave plate and able to receive the right circular polarization and convert it to left circular polarization light; and a mirror positioned in spaced relation to the other side of the quarter wave plate and a half Talbot distance from the phase light modulator, whereby the left circular polarization light reflected from the phase light modulator passes through the quarter wave plate thereby changing the light from the left circular polarization light to horizontally polarized light which then passes to and is reflected by the mirror where it goes through the polarized beam splitter and is converted to right circular polarization light by the 3^{rd} interaction with the quarter wave plate.

According to an aspect is a method for enhancing phase modulation depth for a phase light modulator, comprising the steps of generating a laser light source; forming vertically polarized and collimated light is along a light path through passage of the laser light source through a relay having first and second lenses and a tilted mirror having a central hole formed therethrough positioned between the first and second lenes; receiving and deflecting the vertically polarized and collimated light with a polarized beam splitter positioned in the light path to form a linear polarization light; converting the linear polarization light to right circular polarization light with a quarter wave plate positioned such that the light deflected by the polarized beam splitter passes therethrough; converting the right circular polarization light to left circular polarization light using a phase light modulator positioned in spaced relation to one side of the quarter wave plate; passing the left circular polarization light through the quarter wave plate to convert it to horizontally polarized light; placing a mirror on the other side of the quarter wave plate from the phase light modulator and at a half Talbot distance from the phase light, whereby the horizontally polarized light is reflected by the mirror where it goes through the polarized beam splitter and is converted to right circular polarization light by the 3^{rd} interaction with the quarter wave plate; and modulating the light by the phase light modulator with the same phase modulation profile and reflected to the direction along the incident laser beam via the quarter wave plate and polarized beam splitter.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a block diagram and representation of a MEMS phase light modulator, in accordance with an embodiment.

FIG. 2 is a representational cross-section of the MEMS phase light modulator, in accordance with an embodiment.

FIG. 3 is a schematic representation of the optical enhancement architecture, in accordance with an embodiment.

FIG. 4 is a graphical representation of an experimental result of dual phase modulation by using PLM designed for 2π phase modulation for λ=633 nm.

### DETAILED DESCRIPTION OF EMBODIMENTS

The present disclosure describes a MEMS phase light modulator and method and system for enhancing phase modulation depth for a phase light modulator.

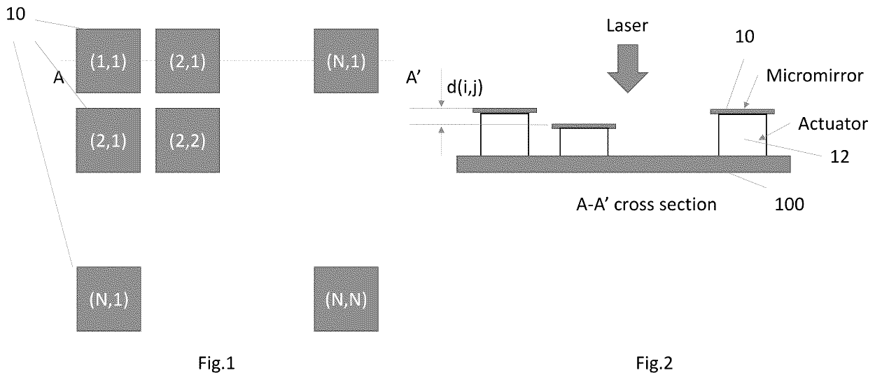

Referring to FIG. 1, a MEMS PLM 100 consists of pixelated micro mirrors 10 that change height of the mirror along the direction of incidence of light. Variation of height of the micromirrors, each of which is securely positioned atop an actuator 12, represented by d(i,j) where (i,j) indicates location of pixel, and is modulated in a pixelated manner. Upon reflection of light by such spatially variable height and pixelated mirrors, phase of light is modulated 2kd(i,j) where k is a light propagation constant in free space, 2π/λ (FIG. 2). Typically, the range of d(i,j) is chosen so that maximum displacement of micromirror d(I,j)=d_max=λ/2, or 2π phase modulation, where lambda is wavelength of laser. The 2π phase modulation maximizes diffraction efficiency in beam steering, by modulating phase 2π with stair-case approximated sawtooth blazed grating.

By PLMs, solid-state, fast, and efficient beam steering is feasible as far as the light is fully modulated in 2π. However for lidar applications, longer wavelength of laser sources, for example, 905 nm and 1550 nm are commonly used. Employing longer wavelength with PLM imposes challenge in its phase modulation depth which is determined by the maximum displacement range of the PLM pixel d(I,j). For example, PLMs designed for visible wavelength (for example 633 nm) suffers from a low diffraction efficiency for 1550 nm due to the insufficient phase modulation depth of 0.4π which is much less than 2π.

A method described here, optical enhancement of phase modulation, overcomes the challenge in insufficient phase modulation of PLM in general, including LCoS, LC, MEMS and others. By the method, insufficient phase modulation, or insufficient range of the mechanical displacement of micromirrors used with longer wavelength is optically enhanced. Consequently, diffraction efficiency is increased at longer wavelength. For example, a PLM designed for wavelength of 633 nm can be usable for wavelength of 905 and 1550 nm while having a higher beam steering efficiency compared to beam steering by PLM without proposed optical enhancement.

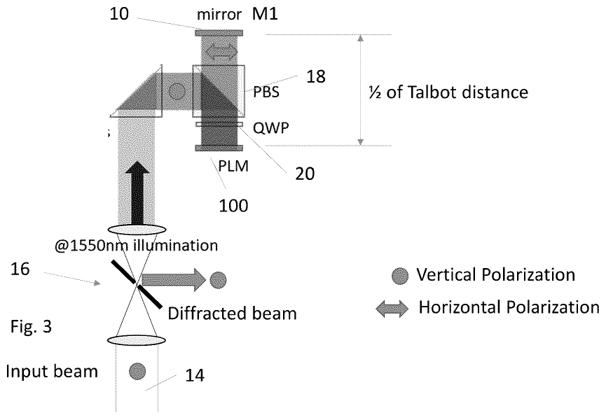

FIG. 3 schematically shows the optical enhancement architecture. A collimated and linearly polarized Laser beam/pulse 14 goes through a 4f, 1:1 relay 16 where a tilted mirror with a center hole is placed at the backfocal point of the first lens. A vertically polarized (VP) and collimated light is deflected by a polarized beam splitter (PBS) 18, followed by passing through a Quarter Wave Plate (QWP) 20 that converts linear polarization (LP) to right circular polarization (RCP). Upon interaction of the RCP light with PLM 100, spatial phase is modulated by 2kd(i,j). PLM reflects and modulates phase of light while changing the handness of polarization from RHP to left hand circular polarization (LCP). The 2^{nd} interaction with QWP 20 changes polarization of light from LCP to horizontally polarized (HP) light. The mirror M1 (10) is placed at a half of the Talbot distance from the PLM as described later. The reflected light by M1 (10) is a HP light, therefore it goes through the PBS 18 and is converted to RCP by the 3^{rd} interaction with QWP 20. Finally the light is modulated by the PLM 100 with the same phase modulation profile and reflected to the direction along the incident laser beam via QWP 20 and PBS 18. After the laser beam is doubly modulated, the laser beam diffracted towards direction defined by the CGH pattern displayed on PLM 100. The diffracted beam is reflected by the mirror placed in the 4f 1:1 collimating optics 16 followed by a collimating optics for beam steering.

The key design parameter of the system to doubly modulate phase by using single PLM is a period of CGH, wavelength λ and optical path length between PLM 100 and mirror M1 (10). The spacing between PLM 100 and M1 (10) is half of the Talbot distance which is given by 2p²/λ, where p is periodicity of phase modulation pattern of PLM. At the Talbot distance, a periodic phase pattern is reproduced without employing imaging optics. The effect is known as Talbot self-imaging. The Talbot self-imaging is commonly referred in reproducing its amplitude. The PLM 100 which is placed at the Talbot distance of modulation pattern of PLM doubly modulates the phase. This double modulation optically increases mechanical traveling range of micromirror by factor of 2. Upon reflection by PLM 100, the RCP changes handness of polarization. The QWP 20 finally change polarization state from LCP to VP. Interaction of VP light with PBS 18 deflects light towards direction of incident light.

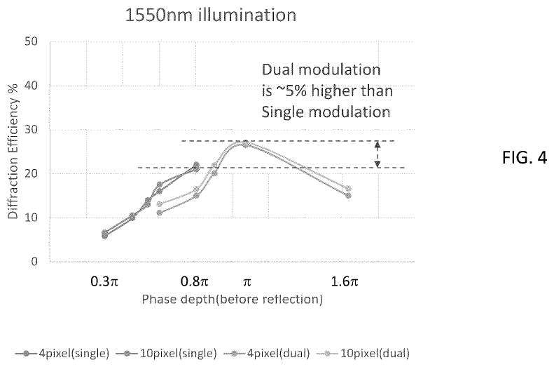

FIG. 4 depicts the experimental result of dual phase modulation by using PLM 100 designed for 2π phase modulation for λ=633 nm. For 1550 nm the maximum phase modulation with conventional single phase modulation is limited to 2π(633 nm/1550 nm)=0.4π. With dual modulation, the phase modulation depth id doubled. Correspondingly, the diffraction efficiency increases from 20% with single modulation to 30% for dual modulation. The experimental results shows feasibility of optically enhancing phase modulation by using reflective PLM 100.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A phase light modulator for use in an optical system having a laser light source that emits light, comprising:
a. a plurality of pixelated micromirrors each of which is selectively movable to vary height in the direction of incidence of the light, wherein variation of height of the micromirrors is represented by d(i,j) where (i,j) indicates location of pixel;
b. means for modulating the micromirrors in a pixelated manner, whereby upon reflection of light by such spatially variable height and pixelated mirrors, phase of light is modulated 2kd(i,j) where k is a light propagation constant in free space, 2π/λ.

2. The phase light modulator of claim 1, wherein the range of d(i,j) is chosen so that maximum displacement of micromirror d(I,j)=d_max=λ/2, or 2π phase modulation, where lambda is wavelength of laser.

3. An optical system for enhancing phase modulation depth for a phase light modulator, comprising:
a. a laser light source;
b. a relay having first and second lenses;
c. a tilted mirror having a central hole formed therethrough positioned between the first and second lenes, whereby vertically polarized and collimated light is formed along a light path;
d. a polarized beam splitter positioned in the light path to receive and deflect the vertically polarized and collimated light;
e. a quarter wave plate positioned such that the light deflected by the polarized beam splitter passes therethrough and converts linear polarization light to right circular polarization light;
f. a phase light modulator positioned in spaced relation to one side of the quarter wave plate and able to receive the right circular polarization and convert it to left circular polarization light;
g. a mirror positioned in spaced relation to the other side of the quarter wave plate and a half Talbot distance from the phase light modulator, whereby the left circular polarization light reflected from the phase light modulator passes through the quarter wave plate thereby changing the light from the left circular polarization light to horizontally polarized light which then passes to and is reflected by the mirror where it goes through the polarized beam splitter and is converted to right circular polarization light by the 3^{rd} interaction with the quarter wave plate.

4. A method for enhancing phase modulation depth for a phase light modulator, comprising the steps of:
a. generating a laser light source;
b. forming vertically polarized and collimated light is along a light path through passage of the laser light source through a relay having first and second lenses and a tilted mirror having a central hole formed therethrough positioned between the first and second lenes;
c. receiving and deflecting the vertically polarized and collimated light with a polarized beam splitter positioned in the light path to form a linear polarization light;
d. converting the linear polarization light to right circular polarization light with a quarter wave plate positioned such that the light deflected by the polarized beam splitter passes therethrough;
e. converting the right circular polarization light to left circular polarization light using a phase light modulator positioned in spaced relation to one side of the quarter wave plate;
f. passing the left circular polarization light through the quarter wave plate to convert it to horizontally polarized light;
g. placing a mirror on the other side of the quarter wave plate from the phase light modulator and at a half Talbot distance from the phase light, whereby the horizontally polarized light is reflected by the mirror where it goes through the polarized beam splitter and is converted to right circular polarization light by the 3^{rd} interaction with the quarter wave plate; and
h. modulating the light by the phase light modulator with the same phase modulation profile and reflected to the direction along the incident laser beam via the quarter wave plate and polarized beam splitter.
